(19) United States
(12) Patent Application Publication
(10) Pub. No.: US 2010/0269499 A1
(43) Pub. Date: Oct. 28, 2010

(54) STIRLING ENGINE SYSTEM AND OPERATING METHOD

(76) Inventors: David Anthony Clark, Cambridgeshire (GB); Alan William McCarthy-Wyper, Oxfordshire (GB)

Correspondence Address: Ballard Spahr LLP, SUITE 1000, 999 PEACHTREE STREET, ATLANTA, GA, 30309-3915, US

(21) Appl. No.: 12/448,744

(22) PCT Filed: Dec. 24, 2007
(86) PCT No.: PCT/GB2007/005020

§ 371 Date: Jul. 8, 2010

(30) Foreign Application Priority Data
Jan. 4, 2007 (GB) 0700141.5

(51) Int. Cl. F02G 1/043

(52) U.S. Cl. 60/517

(57) ABSTRACT

A Stirling engine system comprising a Stirling engine, a burner adjacent to the engine, and a supply of combustible fuel to the burner to produce a hot combusted fuel stream to heat the engine. The system further comprises means to provide relative movement between the burner and engine to increase the proportion of combusted fuel which bypasses the engine as the required heat output increases.

The present invention relates to a Stirling engine system and operating method.

The system has been particularly designed for a Stirling engine system suitable for use in domestic combined heat and power (DCHP) applications. However, the concept is also applicable to other Stirling engine uses.

Stirling engine based DCHP systems use a Stirling engine supplied with heat, for example, from a burner, to generate electricity. Heat is recovered from the exhaust gases from the engine and is used to supply the domestic heat requirement either to heat hot water or a central heating system.

The heat produced in this way is generally insufficient on its own to supply the entire household heat demand. Therefore, Stirling engine based DCHP systems are provided with a supplementary heater to supplement the heat recovered from the Stirling engine exhaust gases.

It is known (from our own earlier WO 04/85820) to provide several burner stages, one dedicated to the engine, a second partly heating the engine and partly a water circuit and a third heating only the water circuit. The second and to a greater degree the third stages provide the supplementary burner.

The present invention is concerned with the design of a simplified system which is cost-effective and is suitable for a small domestic dwelling or a well-insulated dwelling with relatively low heat demand.

According to the present invention there is provided a Stirling engine system comprising a Stirling engine, a burner adjacent to the engine, a supply of combustible fuel to the burner to produce a hot combusted fuel stream to heat the engine, and means to provide relative movement between the burner and engine to increase the proportion of combusted fuel which bypasses the engine as the required heat output increases.

By providing this variable bypass of combusted fuel, the present invention is able to satisfy additional heat demand without the need for an auxiliary burner. This is a much more cost-effective system wherein the need for the supplementary burner and its associated gas train is eliminated. Further, the heat being recovered is from a single stream thereby simplifying the design of heat exchanger required for downstream heat recovery.

The invention could, however, be used in conjunction with an auxiliary burner in an application with a greater heat demand. Although the advantages described above do not apply, the ability to obtain a variable heat output from the engine burner gives more flexible system control. For example, in the prior art, as soon as the heat demand rises slightly above the maximum heat output available from the engine, it is necessary to fire the supplementary burner. This may generate, excess heat. With the present invention, this slight increase in heat demand can be met without having to fire the supplementary burner.

Effectively, the system provides a controlled reduction in engine efficiency (i.e., its ability to generate electricity) from, for example, 20% down to 15% or even 10%. This will enable a 1 kW rated electrical power engine to provide 10 kW of thermal energy without a supplementary burner. This will open up a new market for small or highly insulated dwellings.

The relative movement may be achieved passively. For example, it is known to mount an engine on a number of resilient supports in order to prevent the transmission of engine vibration to the surrounding casing. Generally, such a resilient mounting is made relatively stiff, precisely to prevent excessive movement of the engine. However, it will be possible to replace this stiff support with a more flexible support which is tuned to allowed the engine to displace to a controlled degree as the pressure around the engine head increases in response to increased flow through the burner.

However, preferably, the relative movement is actively controlled. In this case, there is preferably a mechanism which is controlled to move the engine relative to the burner. This mechanism may be positioned beneath the engine to provide a variable force allowing the engine to displace under gravity. Alternatively, the mechanism may be provided to move a support on which the engine is mounted.

The present invention also extends to a method of operating a Stirling engine system to provide heat output and electrical power output, the method comprising supplying a combustible fuel using a fuel supply to a burner adjacent to the engine to provide a hot combusted fuel stream to heat the engine, and moving the burner and engine relative to one another to vary the proportion of the combusted fuel stream which bypasses the engine depending on the heat output required.

Examples of a system and method in accordance with the present invention will now be described with reference to the accompanying drawings, in which:

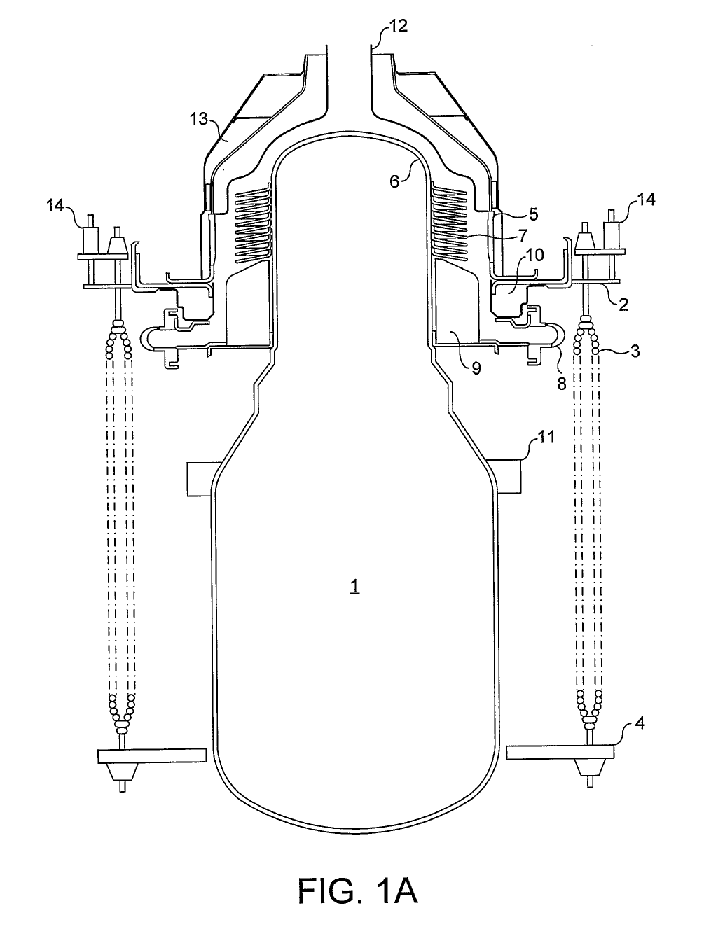

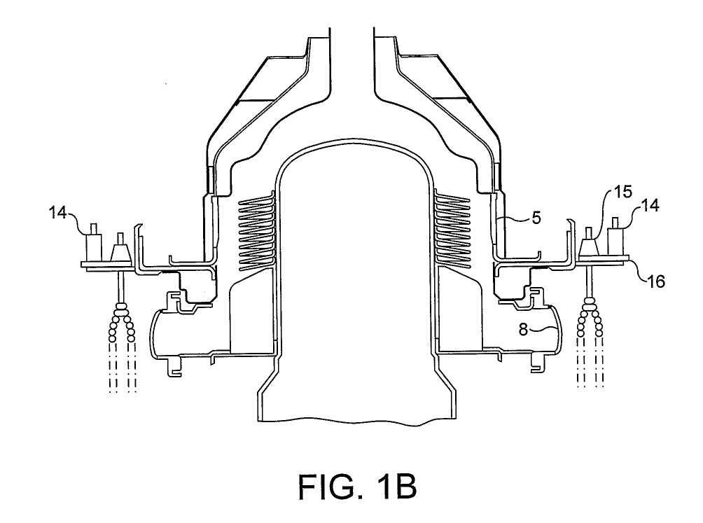

FIG. 1A is a dichromatic cross-section through a first engine assembly in a first position;

FIG. 1B is a similar view of the top of the first engine in a second configuration; and

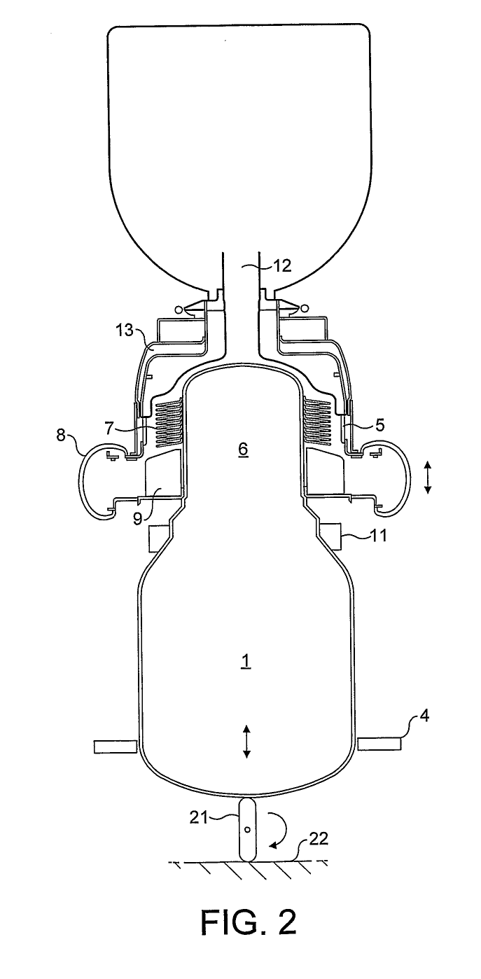

FIG. 2 is a schematic cross-section of a second example.

The basic design of Stirling engine is well known in the art and will not be described in detail here.

The engine is a linear free piston Stirling engine housed in a casing 1. The casing contains, from top to bottom, a displacer, a power piston and an alternator, the details of which are unimportant to the present invention. The engine is suspended from a bracket 2 by a plurality of springs 3 which are connected to a plate 4 attached to the engine. This suspension arrangement is described in detail in WO 03/042566.

Heat is supplied to the engine by a burner 5 having an annular configuration and surrounding the engine head 6 which is provided with a plurality of fins 7 to facilitate heat transfer into the engine.

The combustion chamber is sealed at its lower end by a flexible seal 8. An annular block of insulation 9 and an annular coolant channel 10 are provided to reduce the temperature to which the flexible seal 8 is exposed. This is described in PCT/GB 2006/002254. A coolant channel 11 surrounds the central portion of the housing 1. The temperature differential created by the burner 5 and coolant channel 11 drives the displacer and power piston which generates electricity at the alternator.

The exhaust from the burner 5, once it has given up heat to the engine head 6, flows over the top of the head and through the exhaust gas outlet 12. On the way it gives further heat to incoming air in intake duct 13 leading to the burner 5 to pre-heat this air. The exhaust duct 12 leads to a heat exchanger (not shown) where its heat is recovered in order to service some of the domestic heat requirement.

The amount of heat generated in this way is insufficient to supply the total domestic demand, therefore, it is known to provide an auxiliary burner to satisfy this additional demand.

The present invention is able to provide additional heat output thereby avoiding the need for an auxiliary burner, particularly for applications with a relatively low heat demand. This is done in general terms by increasing the amount of hot combustion gases from the burner 5, which bypass the engine head 6 thereby significantly increasing the temperature of the exhaust gases in the exhaust duct 12. This can be done at the expense of electrical output from the engine. Alternatively, the burner can be “over-fired” thereby optimising the performance of the engine and producing additional heat.

The mechanism for achieving this will now be described, with reference to FIGS. 1A and 1B. In this example, a separate actuator 14 may be provided for each spring 3, or there may be a single actuator attached to all of the springs by an appropriate linkage. Alternatively, the springs may be grouped together and a single actuator may be provided for each group. The or each actuator 14 is connected to a plug 15 at the top of each spring 3 by a plate 16. The actuator 14 which may be, for example, a solenoid or piezoelectric actuator, is operable to move the spring from the raised position shown in FIG. 1A to the lowered position shown in FIG. 1B.

As a result of lowering the engine, it can be seen that the flexible seal 8 has been extended and that the clearance above the engine head has increased. A movement of around 1 cm is envisaged. A comparison of FIGS. 1A and 1B demonstrates that the engine is positioned such substantially all of the flow from the burner impinges on the fins 7 when the engine is in the raised position of FIG. 1A, while when it is in the lowered position shown in FIG. 1B a significant proportion of the flow bypasses the fins.

As currently illustrated in FIG. 1A, the actuators 14 bear the entire weight of the engine assembly. Therefore, a ratchet mechanism is preferably provided to support the engine to allow the actuators 14 only to draw power when the engine position is being altered:

Preferably, the position of the actuators 14 is continuously (or nearly continuously) variable. This allows for the engine position to be accurately set for a required thermal load whilst maintaining the electrical output without overrunning the engine. Use of the ratchet mechanism is useful to assist in this as the actuators would otherwise have a tendency to relax over time.

A second example of the system is shown in FIG. 2. The basic features of the engine are as described with reference to FIG. 1. In this case, the actuator mechanism 14 has been replaced by an engine positioning device 21. Essentially, this is a rotatable cam mechanism which is rotatable to lift the engine between the raised and lowered position relative to a fixed reference position 22 on the mounting frame. Again, the seals 8 are flexible to accommodate this movement. This example can readily be implemented with a single actuator. However, the vibration effect of the springs 3 (which are present in the example of FIG. 2 although not shown in the drawing) is to some extent negated by the mechanical linkage between the engine and engine positioner 21. This problem can be reduced to some extent by using a cam arrangement which allows some relative movement between the engine and support such as a slotted connection to the engine.

1. A Stirling engine system comprising a Stirling engine, a burner adjacent to the engine, a supply of combustible fuel to the burner to produce a hot combusted fuel stream to heat the engine, and means to provide relative movement between the burner and engine to increase the proportion of combusted fuel which bypasses the engine as the required heat output increases.

2. A system according to claim 1, wherein the relative movement is actively controlled.

3. A system according to claim 2, comprising a mechanism which is controlled to move the engine relative to the burner.

4. A system according to claim 3, wherein the mechanism is positioned beneath the engine to provide a variable force allowing the engine to displace under gravity.

5. A system according to claim 3, wherein the mechanism is provided to move a support on which the engine is mounted.

6. A method of operating a Stirling engine system to provide heat output and electrical power output, the method comprising supplying a combustible fuel using a fuel supply to a burner adjacent to the engine to provide a hot combusted fuel stream to heat the engine, and moving the burner and engine relative to one another to vary the proportion of the combusted fuel stream which bypasses the engine depending on the heat output required.
